(19) United States
(12) Patent Application Publication
(10) Pub. No.: US 2021/0188163 A1
(43) Pub. Date: Jun. 24, 2021

(54) U-TURN SIGNAL INDICATOR

(71) Applicant: Geoffrey M. KERN, Newport, NC (US)

(72) Inventor: Geoffrey M. KERN, Newport, NC (US)

(21) Appl. No.: 16/723,248

(22) Filed: Dec. 20, 2019

(51) Int. Cl. B60Q 1/52; H04N 7/18; B60R 1/00; B60Q 1/30; B60Q 1/28; B60Q 1/04; B60Q 5/00

(52) U.S. Cl. CPC B60Q 1/525; H04N 7/183; B60R 1/00; B60R 2300/80; B60Q 1/28; B60Q 1/04; B60Q 5/005; B60Q 1/30

(57) ABSTRACT

A U-turn signal indicator system for a vehicle includes an indicator assembly including a first portion that may have a first color, and a second portion configured to form a symbol for a U-turn. The second portion may have a second color that contrasts with the first color. The U-turn signal indicator system may further include a light emitting element configured to illuminate the first portion and the second portion, and a control device configured to activate the light emitting element.

### BACKGROUND

Motor vehicles are required to have turn signal indicators to indicate that a vehicle will make a turn. The turn signal indicators allow other motorists and pedestrians to know ahead of time when a vehicle will make the turn as well as the direction that the vehicle will turn. The indicators typically involve flashing lights on the front, rear, and sometimes the side of the vehicle to provide a warning that the vehicle will be slowing down to make a turn to the left or to the right.

In some cases, however, a vehicle may need to reverse direction by making a U-turn (i.e., an approximately 180-degree turn). In preparation for making the U-turn, a vehicle may slow down more than other drivers expect for a vehicle making a left-hand turn or right-hand turn. A driver of a following vehicle may misjudge the additional slow-down of the vehicle making the U-turn which can result in a rear-end collision. Further, when a turn signal indicator is flashing, drivers of oncoming vehicles may expect the turning vehicle to make a normal turn and may not slow down sufficiently to avoid a collision with a slower moving vehicle making a U-turn into the travel lane. In some cases, a pedestrian may not expect the vehicle to make a U-turn and may accidentally step into the path of the turning vehicle. This makes U-turns a dangerous maneuver that results in serious accidents. Regulators and lawmakers have sought to restrict U-turns, but have not make the U-turn a safe maneuver. Therefore for safety improvements are needed for vehicles making U-turns.

### SUMMARY

Apparatuses and systems for indicating that a vehicle will make a U-turn are provided.

According to various aspects there is provided a U-turn signal indicator system for a vehicle, for allowing a vehicle to signal when the turning into the opposing direction, e.g., opposing traffic lanes. The U-turn may be made across a divided highway. The U-turn may be performed by a vehicle from an activate motion, or from a parked position. It should be readily appreciated that by the term U-turn and 180-degree turn may be used interchangeable and includes any variation in degree, e.g., from approximately 120-degree to 220-degree, so long as the turn is into the opposing direction previously travelled. In addition, a U-turn may require a k-turn or a 3-point turn to complete the turn. In some aspects, the U-turn signal indicator system may include an indicator assembly including a first portion that may have a first color, and a second portion configured to form a symbol for a U-turn. The second portion may have a second color that contrasts with the first color, for example, colors that provides highly visible contrasts. This makes the U-turn signal indicator distinctive to other vehicles in poorly lit or dark areas of roadway. The U-turn signal indicator system may further include a light emitting element configured to illuminate the first portion and the second portion, and a control device configured to activate the light emitting element.

The 180-degree turn signal indicator system may further include a camera configured to capture an image of an area adjacent to the vehicle in a direction of the U-turn. The camera may be configured to be activated by the control device together with the light emitting element. The camera may be configured to transmit the image to a video monitor or display disposed at an interior of the vehicle.

The U-turn signal indicator system may further include a proximity sensor that may be configured to sense an object in proximity to the vehicle in a direction of the U-turn and may cause an audible alarm to an interior of the vehicle. The proximity sensor may be configured to be activated by the control device together with the light emitting element. In some implementations, the proximity sensor may be a radar sensor.

The U-turn signal indicator system may further include an audible alarm device that may be configured to emit a warning sound external to the vehicle. The audible alarm device may be configured to be activated by the control device together with the light emitting element.

In some cases, the control device may be configured to activate the light emitting element to cause the first portion of the indicator assembly to illuminate steadily, e.g., without flashing or no more than 5 flashes per minute, and to cause the second portion of the indicator assembly configured to form the symbol for the U-turn to flash at a predetermined rate, e.g., from 60 to 120 flashes per minute. In some cases, the control device may be configured to activate the light emitting element to cause the first portion of the indicator assembly to flash at a predetermined rate, e.g., from 60 to 120 flashes per minute, and cause the second portion of the indicator assembly configured to form the symbol for the U-turn to illuminate steadily, e.g., without flashing or no more than 5 flashes per minute.

In some implementations, the indicator assembly may be included in a side marker assembly. The side marker assembly may include a camera that may be configured to capture an image of an area adjacent to the vehicle, and an audible alarm device that may be configured to emit a warning sound external to the vehicle. The camera and the audible alarm device may be configured to be activated by the control device together with the light emitting element.

In some implementations, the indicator assembly may be included in a taillight assembly. The taillight assembly may include a camera that may be configured to be activated by the control device together with the light emitting element and to capture an image of an area adjacent to the vehicle. In some implementations, the indicator assembly may be included in a headlight assembly.

According to various aspects there is provided a taillight assembly for a vehicle. In some aspects, the taillight assembly may include a U-turn signal indicator including a first portion that may be configured to be illuminated in a first color, and a second portion that may be configured to form a symbol for a U-turn. The second portion may be configured to be illuminated in a second color that contrasts with the first color, for example, a color that provides highly visible contrast.

In some implementations, the first portion of the U-turn signal indicator may be configured to illuminate steadily, e.g., without flashing or no more than 5 flashes per minute, and the second portion of the U-turn signal indicator may be configured to flash at a predetermined rate, e.g., from 60 to 120 flashes per minute. In some implementations, the first portion of the U-turn signal indicator may be configured to flash at a predetermined rate, e.g., from 60 to 120 flashes per minute, and the second portion of the U-turn signal indicator is configured to illuminate steadily, e.g., without flashing or no more than 5 flashes per minute.

The taillight assembly may further include a camera that may be configured to be activated together with the U-turn signal indicator to capture an image of an area adjacent to the vehicle. This area may be of the opposing traffic travel lanes, which can include both in front of the vehicle and behind the vehicle. Several different types of cameras may be used, as described herein. To capture the area, the camera may be a fish eye camera or may include multiple cameras that provide multiple images or a composite image. The camera may be configured to transmit the image to a video monitor or display disposed in the interior of the vehicle.

According to various aspects there is provided a headlight assembly for a vehicle. In some aspects, the headlight assembly may include a U-turn signal indicator including a first portion that may be configured to be illuminated in a first color, and a second portion that may be configured to form a symbol for a U-turn. The second portion may be configured to be illuminated in a second color that contrasts with the first color, for example, a color that provides highly visible contrast. The U-turn signal indicator may be disposed on a lens of the headlight assembly at a location visible to oncoming traffic.

Numerous benefits are achieved by way of the various embodiments over conventional techniques. For example, the various embodiments provide an indicator to signal the intention of a driver of a vehicle to make a U-turn, thereby increasing the safety of nearby pedestrians as well as other drivers of other vehicles. In some embodiments, the U-turn indicator may be activated using a turn signal lever in a manner similar to activation of a typical turn signal indicator. In some embodiments, the U-turn indicator may be activated using a button on the dashboard or located elsewhere in the interior of the vehicle. These and other embodiments along with many of its advantages and features are described in more detail in conjunction with the text below and attached figures.

### BRIEF DESCRIPTION OF THE DRAWINGS

Aspects and features of the various embodiments will be more apparent by describing examples with reference to the accompanying drawings, in which:

FIG. 1 is a diagram illustrating an example of a circle type marker assembly including a U-turn indicator according to some aspects of the present disclosure;

FIG. 2 is a diagram illustrating an example of a rectangular type marker assembly including a U-turn indicator according to some aspects of the present disclosure;

FIG. 3 is a diagram illustrating an example of a taillight assembly including a U-turn indicator according to some aspects of the present disclosure;

FIG. 4 is a diagram illustrating an example of a headlight assembly including a U-turn indicator according to some aspects of the present disclosure according to some aspects of the present disclosure;

FIG. 5 is a diagram illustrating an example of a video monitor according to some aspects of the present disclosure;

FIG. 6 is a block diagram illustrating an example of a U-turn indicator system according to some aspects of the present disclosure;

FIG. 7 is a diagram illustrating a headlight and a marker assembly including U-turn indicators disposed in example locations on a vehicle according to some aspects of the present disclosure; and

FIG. 8 is a diagram illustrating a taillight including a U-turn indicator disposed in an example location on a vehicle according to some aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

Motor vehicle turn signal indicators allow other motorists and pedestrians to know ahead of time when a vehicle will make a turn, typically using flashing lights on the front, rear, and sometimes the side, of the vehicle. When making a U-turn, for example, a turn of approximately 120-degree to 220-degree, so long as the turn is into the opposing direction previously travelled, a vehicle may slow down more than more than other drivers of following vehicles expect when a typical left-hand or right-hand turn signal indicator is flashing. In addition, a U-turn may require a k-turn or a 3-point turn to complete the turn. The slower than expected speed of the vehicle making the U-turn can result in a collision with a following vehicle or with an on-coming vehicle. Pedestrians may also be endangered by stepping into the path of a vehicle making a U-turn rather than a typical 90-degree turn. The terms U-turn and 180-degree turn may be used interchangeably herein to mean a turn of approximately 120-degree to 220-degree into the opposing direction previously travelled. Further, a U-turn may include a k-turn or a 3-point turn.

In accordance with aspects of the present disclosure, a U-turn signal indicator for a vehicle is provided. The U-turn signal indicator may provide a visual indication to motorists and pedestrians that the driver of a vehicle is preparing to make a U-turn. In some implementations, the U-turn signal indicator may provide an audible signal external to the vehicle indicating that the vehicle is about to make a U-turn. The audible signal may act as a warning to pedestrians. In some implementations, a video capture device may be associated with the U-turn signal indicator and may provide the driver of the vehicle with a view of the area surrounding the vehicle, for example, to determine whether a pedestrian may be near the vehicle. In some implementations, proximity of pedestrians may be detected by, for example, radar, infrared devices (e.g., proximity sensors), or other pedestrian detection devices, that may alert the driver that a pedestrian may be near the vehicle.

The U-turn signal indicator may be activated by a control device located within or adjacent to the driver portion of the vehicle interior. For example, the control device may be mounted on or integrated with the vehicle directional lever. Alternatively, the control device may be a button mounted on the vehicle dashboard, for example, as part of a vehicle original equipment video monitor or an aftermarket video monitor. In some implementations, the U-turn signal indicator may include a power source, for example, a battery. In some implementations, power for the U-turn signal indicator may be provided by connections to the vehicle electrical system.

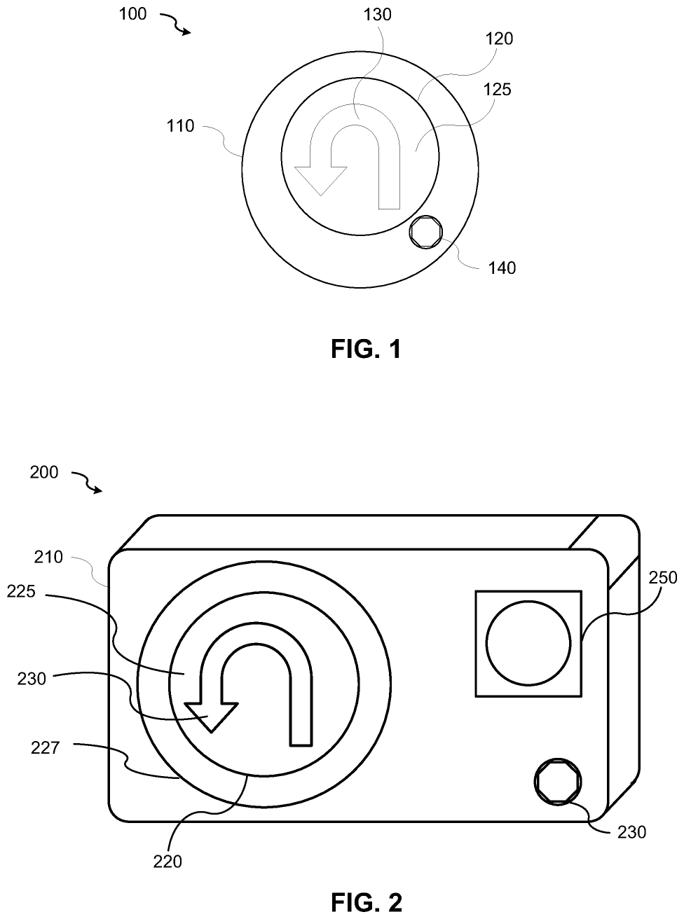

FIG. 1 is a diagram illustrating an example of a circle type marker assembly including a U-turn signal indicator according to various embodiments. As illustrated in FIG. 1, the circle type marker assembly 100 may include a substantially circular marker assembly housing 110. The circle type marker assembly 100 may be positioned on a vehicle, for example, on a fender, bumper, side view mirror, etc., on a side of a vehicle in a direction in which the vehicle turns during a U-turn (e.g., on the left-hand side (driver side) in the United States).

A U-turn signal indicator 120 may be mounted in the circle type marker assembly 100. The U-turn signal indicator 120 may include a solid portion 125 and a portion having a recognizable symbol 130, for example, an arrow representing a U-turn or another symbol representing a U-turn. The solid portion 125 may have a contrasting color to the symbol portion 130. For example, the solid portion 125 may be red colored while the symbol portion 130 may be white. Other colors, for example, colors that provides highly visible contrasts, may be used without departing from the scope of the present disclosure.

The U-turn signal indicator 120 may provide a warning to nearby pedestrians that the vehicle is attempting to make a U-turn. When activated, the U-turn signal indicator 120 may be illuminated, for example, by a lamp, a light emitting diode, a fiber optic cable, or another light source. The U-turn signal indicator 120 may flash at a predetermined rate when activated. For example, the U-turn signal indicator 120 may flash at a rate similar to flashing rate of a directional indicator. Alternatively, the U-turn signal indicator 120 may be steadily illuminated and disposed within a flashing marker assembly. For example, the circular marker assembly housing 110 may be configured as a flashing directional indicator while the U-turn signal indicator 120, when activated, may be steadily illuminated within the flashing directional indicator.

In some implementations, the U-turn signal indicator 120 may be flashing and disposed within a steadily illuminated marker assembly housing 110. In some implementations, both the solid portion 125 and the symbol portion 130 of the U-turn signal indicator 120 may be steadily illuminated or flashing. In other implementations, either the solid portion 125 or the symbol portion 130 of the U-turn signal indicator 120 may be steadily illuminated or flashing. Other implementations are possible without departing from the scope of the present disclosure.

In some implementations, the circle type marker assembly 100 may include a camera 140. The camera 140 may be activated when the U-turn signal indicator 120 is activated. The camera 140 may be a solid state image sensor, for example, but not limited to, a charge-coupled device (CCD), an active pixel sensor, or other type of solid state image sensor or camera device. The camera 140 may be a video camera or may provide still-images that may be updated at a specified time period, for example, every one second or another time period, when the camera 140 is activated.

The camera 140 may provide a visual indication, for example, on a video monitor, of the area around the vehicle on which the circle type marker assembly 100 is mounted. For example, the camera 140 may provide an image of an area to the side of the vehicle in the direction in which the vehicle is making a U-turn. The image provided by the camera 140 may enable a driver to see pedestrians or obstructions in the path of the anticipated U-turn. The camera 140 located on the circle type marker assembly 100 may allow a driver to see objects located in a blind spot caused by the roof pillar on the side of the windshield (also known as an “A” pillar).

In some implementations, the circle type marker assembly 100 may additionally or alternatively include a radar, electromagnetic radiation (infrared) or other proximity sensor (not shown). The radar sensor may be, for example, but not limited to, and ultra wideband (UWB) sensor. The proximity sensor may be activated when the U-turn signal indicator is activated. For purposes of the present disclosure, the proximity sensor should be capable of detecting movable objects such as vehicles, pedestrians, and/or animals, and stationary objects such as poles, jersey walls, and/or barriers. The proximity sensor may cause an audible alert or alarm to be generated in the interior of the vehicle to notify the driver that pedestrians or obstructions are in the path of the anticipated U-turn.

FIG. 2 is a diagram illustrating an example of a rectangular type marker assembly including a U-turn signal indicator according to some embodiments. Referring to FIG. 2, the rectangular type marker assembly 200 may include a substantially rectangular housing 210 or a substantially square housing. The rectangular type marker assembly 200 may be positioned on a vehicle, for example, on a fender, bumper, side view mirror, etc., on a side of a vehicle in a direction in which the vehicle turns during a U-turn (e.g., on the left-hand side (driver side) in the United States). A U-turn signal indicator 220 may be mounted in the rectangular type marker assembly 200.

The U-turn signal indicator 220 may include a solid portion 225 and a portion having a recognizable symbol 230, for example, an arrow representing a U-turn or another symbol representing a U-turn. The solid portion 225 may have a contrasting color to the symbol portion 230. For example, the solid portion 225 may be red colored while the symbol portion 230 may be white. Other colors, for example, colors that provides highly visible contrasts, may be used without departing from the scope of the present disclosure. The U-turn signal indicator 220 may be substantially similar to the U-turn signal indicator 120 described with respect to FIG. 1.

The U-turn signal indicator 220 may provide a warning to nearby pedestrians that the vehicle is attempting to make a U-turn. When activated, the U-turn signal indicator 220 may be illuminated, for example, by a lamp, a light emitting diode, a fiber optic cable, or another light source. The U-turn signal indicator 220 may flash at a predetermined rate when activated. For example, the U-turn signal indicator 220 may flash at a rate similar to the rate of a flashing directional indicator. Alternatively, the U-turn signal indicator 220 may be steadily illuminated and disposed within a flashing marker assembly. For example, the U-turn signal indicator 220 may include a flashing directional indicator 227 while the U-turn signal indicator 220, when activated, may be steadily illuminated within the flashing directional indicator 227.

In some implementations, the U-turn signal indicator 220 may be flashing and disposed within a steadily illuminated marker assembly. In some implementations, both the solid portion 225 and the symbol portion 230 of the U-turn signal indicator 220 may be steadily illuminated or flashing. In other implementations, either the solid portion 225 or the symbol portion 230 of the U-turn signal indicator 220 may be steadily illuminated or flashing. Other implementations are possible without departing from the scope of the present disclosure. In some implementations, a flashing directional indicator may be located on the rectangular housing 210 at a position separated from the U-turn signal indicator 220.

In some implementations, the rectangular type marker assembly 200 may include a camera 240. The camera 240 may be activated when the U-turn signal indicator 220 is activated. The camera 240 may be a solid state image sensor, for example, but not limited to, a charge-coupled device (CCD), an active pixel sensor, or other type of solid state image sensor or camera device. The camera 240 may be a video camera or may provide still-images that may be updated at a specified time period, for example, every one second or another time period, when the camera 240 is activated.

The camera 240 may provide a visual indication, for example, on a display of a video monitor located in the interior of the vehicle, of the area around the vehicle on which the rectangular type marker assembly 200 is mounted. For example, the camera 240 may provide an image of an area to the side of the vehicle in the direction in which the vehicle is making a U-turn. The image provided by the camera 240 may be displayed on the video monitor located in the interior of the vehicle and may enable a driver to see pedestrians or obstructions in the path of the anticipated U-turn. The camera 240 located on the rectangular type marker assembly 200 may allow a driver to see objects located in a blind spot caused, for example, by the roof pillar on the side of the windshield (also known as an “A” pillar).

In some implementations, the rectangular type marker assembly 200 may additionally or alternatively include a radar or other proximity sensor as described above. The proximity sensor may cause an audible alarm to be generated in the interior of the vehicle to notify the driver that pedestrians or obstructions are in the path of the anticipated U-turn.

In some implementations, the rectangular type marker assembly 200 may include an audio output transducer 250. The audio output transducer 250 may be activated when the U-turn signal indicator 220 is activated and may provide an audible alarm external to the vehicle to notify pedestrians or others in the vicinity of the vehicle that the vehicle is about to make a U-turn. The audio output transducer 250 may be, for example, but not limited to, a piezoelectric transducer, a vibration transducer, an electrostatic transducer, or other type of audio output transducer.

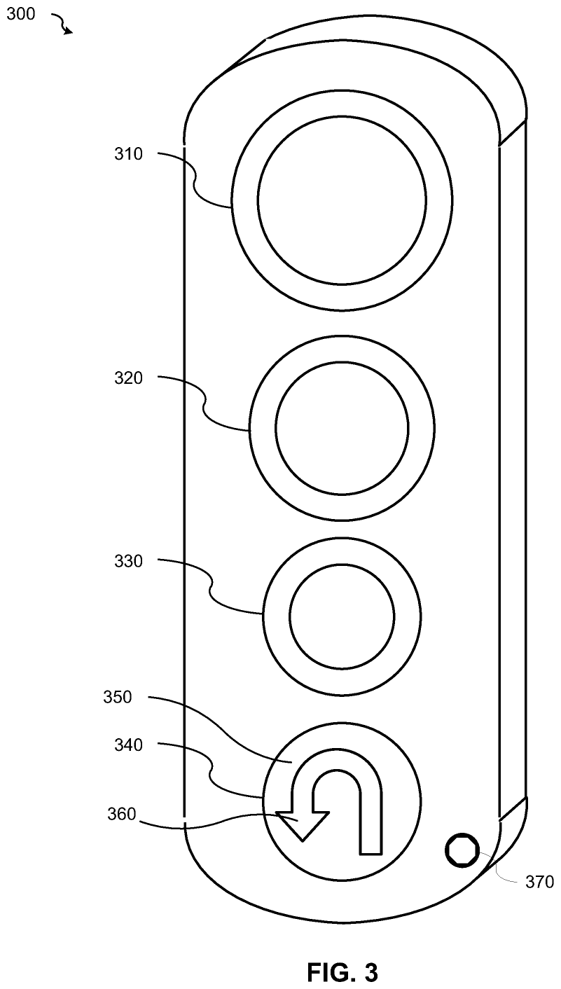

FIG. 3 is a diagram illustrating an example of a taillight assembly including a U-turn signal indicator according to some aspects of the present disclosure. Referring to FIG. 3, the taillight assembly 300 may include a brake light 310, a running light 320, and a backup lights 330 has typically found on a vehicle. According to some aspects of the present disclosure, the taillight assembly 300 may also include a U-turn signal indicator 340. The U-turn signal indicator 340 may include a solid portion 350 and a portion having a recognizable symbol 360, for example, an arrow representing a U-turn or another symbol representing a U-turn. The solid portion 350 may have a contrasting color to the symbol portion 360. For example, the solid portion 350 may be red colored while the symbol portion 360 may be white. Other colors, for example, colors that provides highly visible contrasts, may be used without departing from the scope of the present disclosure.

The U-turn signal indicator 340 may provide a warning to drivers of following vehicles that the vehicle is attempting to make a U-turn. When activated, the U-turn signal indicator 340 may be illuminated, for example, by a lamp, a light emitting diode, a fiber optic cable, or another light source. The U-turn signal indicator 340 may flash at a predetermined rate, e.g., from 60 to 120 flashes per minute, when activated. For example, the U-turn signal indicator 340 may flash at a rate similar to the rate of a flashing directional indicator. Alternatively, the U-turn signal indicator 340 may be steadily illuminated, e.g., without flashing or no more than 5 flashes per minute. In some implementations, both the solid portion 350 and the symbol portion 360 of the U-turn signal indicator 340 may be steadily illuminated or flashing. In other implementations, either the solid portion 350 or the symbol portion 360 of the U-turn signal indicator 340 may be steadily illuminated or flashing. Other implementations are possible without departing from the scope of the present disclosure.

In some implementations, the taillight assembly 300 may include a camera 370. Multiple cameras may be used to capture the area adjacent to the vehicle in a direction of the U-turn. The camera 370 may be activated when the U-turn signal indicator 340 is activated. The camera 370 may be a solid state image sensor, for example, but not limited to, a charge-coupled device (CCD), an active pixel sensor, or other type of solid state image sensor or camera device. The camera 370 may be a video camera or may provide still-images that may be updated at a specified time period, for example, every one second or another time period, when the camera 370 is activated.

The camera 370 may provide a visual indication, for example, on a display of a video monitor located in the interior of the vehicle, of the area around the vehicle on which the taillight assembly 300 is mounted. For example, the camera 370 may provide an image of an area to the rear of the vehicle while the vehicle is attempting to make a U-turn. The image provided by the camera 370 may be displayed on the video monitor located in the interior of the vehicle and may enable a driver to see pedestrians or obstructions near the vehicle during the anticipated U-turn. The camera 370 located on the taillight assembly 300 may allow a driver to see objects located in a blind spot caused by the roof pillar behind the rear doors of the vehicle (also known as a “C” pillar or a “D” pillar).

One of ordinary skill in the art will appreciate that the illustrated shape of the example taillight assembly is merely for purposes of explanation and not meant to illustrate a specific taillight assembly shape. The U-turn indicator may be incorporated into taillight assemblies of various shapes and configurations without departing from the scope of the present disclosure.

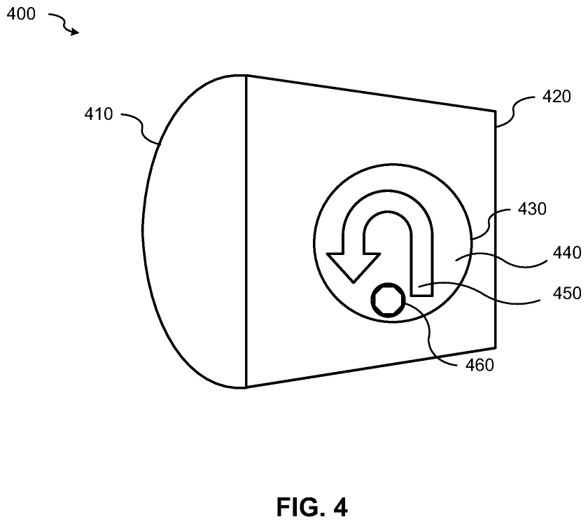

FIG. 4 is a diagram illustrating an example of a headlight assembly including a U-turn signal indicator according to some aspects of the present disclosure. As illustrated in FIG. 4, the headlight assembly may include a headlight lens 410 attached to a headlight housing 420. The lens 410 may permit illumination to be provided by an illumination element (not shown) of the headlight assembly 400.

According to some aspects of the present disclosure, a U-turn signal indicator 430 may be included on a side portion of the headlight assembly 400 in a direction consistent with a direction in which the vehicle may attempt a U-turn. In some implementations, the U-turn signal indicator 430 may be included as part of the headlight housing 420. In some implementations, the U-turn signal indicator 430 may be included as part of the headlight lens 410. Additionally or alternatively, the U-turn signal indicator 430 may be included as part of the headlight lens 410 in a location visible to oncoming traffic.

The U-turn signal indicator 430 may include a solid portion 440 and a portion having a recognizable symbol 450, for example, an arrow representing a U-turn or another symbol representing a U-turn. The solid portion 440 may have a contrasting color to the symbol portion 450. For example, the solid portion 440 may be red colored while the symbol portion 450 may be white. Other colors, for example, colors that provides highly visible contrasts, may be used without departing from the scope of the present disclosure.

The U-turn signal indicator 430 may provide a warning to nearby pedestrians that the vehicle is attempting to make a U-turn. When activated, the U-turn signal indicator 430 may be illuminated, for example, by a lamp, a light emitting diode, a fiber optic cable, or another light source. The U-turn signal indicator 430 may flash at a predetermined rate, e.g., from 60 to 120 flashes per minute, when activated. For example, the U-turn signal indicator 430 may flash at a rate similar to the rate of a flashing directional indicator. Alternatively, the U-turn signal indicator 430 may be steadily illuminated, e.g., without flashing or no more than 5 flashes per minute. In some implementations, both the solid portion 440 and the symbol portion 450 of the U-turn signal indicator 430 may be steadily illuminated or flashing. In other implementations, either the solid portion 440 or the symbol portion 450 of the U-turn signal indicator 430 may be steadily illuminated or flashing. Other implementations are possible without departing from the scope of the present disclosure.

In some implementations, a camera 460 may be incorporated into the U-turn signal indicator 430. In some implementations, the camera 460 may be incorporated into the headlight assembly 400 separate from the U-turn signal indicator 430 (not shown). The camera 460 may be a solid state image sensor, for example, but not limited to, a charge-coupled device (CCD), an active pixel sensor, or other type of solid state image sensor or camera device. The camera 460 may be a video camera or may provide still-images that may be updated at a specified time period, for example, every one second or another time period, when the camera 460 is activated.

The camera 460 may provide an image of an area to the side of the vehicle in the direction in which the vehicle is making a U-turn. The image provided by the camera 460 may be displayed on the video monitor located in the interior of the vehicle and may enable a driver to see pedestrians or obstructions in the path of the anticipated U-turn. For example, a pedestrian or obstruction may be disposed in a blind spot caused by the “A” roof pillar of the vehicle on the side of the windshield. The camera 460 may enable the driver to see the pedestrian or obstruction on the video monitor.

One of ordinary skill in the art will appreciate that the illustrated shape of the example headlight assembly is merely for purposes of explanation and not meant to illustrate a specific headlight assembly shape. The U-turn signal indicator may be incorporated into headlight assemblies of various shapes and configurations without departing from the scope of the present disclosure.

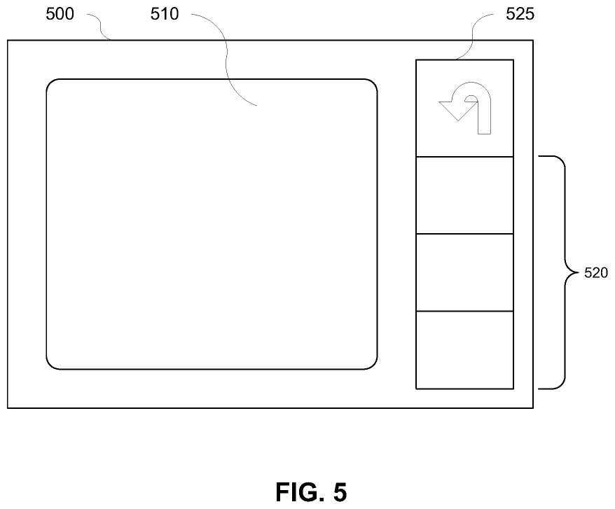

FIG. 5 is a diagram illustrating an example of a video monitor according to some aspects of the present disclosure. The video monitor 500 may include a video display screen 510 and one or more selection buttons 520. The selection buttons 520 may control various features of the video monitor. The video monitor 500 may also include a U-turn signal indicator control button 525. In some implementations, the video display screen 510 may be a touch screen display and the selection buttons 520 or the U-turn signal indicator control button 525 or both may be displayed and enabled by the touch screen display. Operating the U-turn signal indicator control button 525 may activate and deactivate the U-turn signal indicator. In some implementations, operating the U-turn signal indicator control button 525 may also activate and deactivate the camera or the radar or proximity sensor or both.

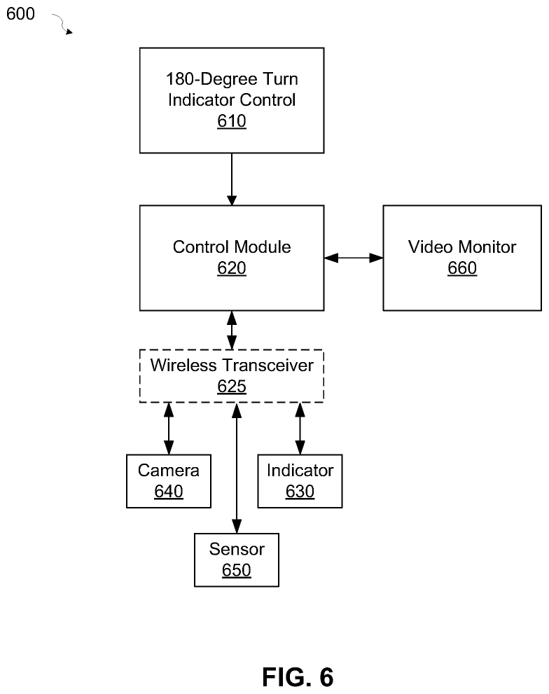

FIG. 6 is a block diagram illustrating an example of a U-turn signal indicator system according to some aspects of the present disclosure. The U-turn signal indicator system 600 may include a U-turn indicator control device 610, a control module 620, one or more U-turn signal indicators 630, one or more cameras 640, one or more radar or proximity sensors 650, and a video monitor 660. Various implementations may not include all of the components illustrated in FIG. 6. For example, some implementations may not include a radar or proximity sensor. Other implementations may not include a camera and video monitor.

The control device 610 may be, for example, a mechanical switch or electronic circuitry configured to activate and deactivate the U-turn signal indicator 630. In some implementations, the control device 610 may provide signals to a vehicle electronic control unit (ECU) (not shown) to cause the vehicle ECU to transmit signals to cause the U-turn signal indicator 630 to be activated and deactivated. In some implementations, the control device 610 may provide the signals to the U-turn signal indicator 630 to be activated and deactivated. In other implementations, the control device 610 may provide signals directly to the U-turn signal indicator 630 to cause the U-turn signal indicator to be activated and deactivated. The control signal may be transmitted to the U-turn signal indicator 630 wirelessly or via a wired connection. The U-turn indicator may be activated wirelessly, for example, via Bluetooth®, Wi-Fi®, or another wireless technology.

In some cases, the control module 620 may provide wired connections to the U-turn signal indicator 630 or the camera 640 or the radar or proximity sensor 650 or all of them. In other cases, the control module 620 may provide wireless connections to the U-turn signal indicator 630 or the camera 640 or the radar or proximity sensor 650 or all of them. For implementations that provide wireless connections, a wireless transceiver 625 may be included. Various combinations of the above components may be included in the U-turn signal indicator system 600 without departing from the scope of the present disclosure.

The control device 610 may be located within or adjacent to the driver side of the vehicle interior. For example, the control device 610 may be incorporated into a turn signal indicator lever. The turn signal indicator lever for a vehicle is typically located on the steering column and is used to activate directional signals. For example, moving the turn signal indicator lever upwards from a neutral position activates a right hand turn signal indicator and moving the turn signal indicator level downwards from a neutral position activates a left-hand turn signal indicator. In some implementations, the turn signal indicator lever may be positionable at an additional downward (left-hand) position to activate the U-turn signal indicator 630. In some implementations an additional control, for example, but not limited to, a button, may be incorporated into the turn signal indicator lever or placed elsewhere to activate the U-turn signal indicator 630.

In some implementations of the control device 610 may activate the U-turn signal indicator 630 via a wired connection. The wired connection may be through the vehicle wiring harness or may be via wiring connections made external to the vehicle wiring harness. When connected to the vehicle wiring harness, activation of the U-turn signal indicator 630 may involve control by one of the vehicle on-board computers or controllers (e.g., a vehicle ECU). In some implementations, the control module 620 may wirelessly activate the U-turn signal indicator 630 via the wireless transceiver 625 using a wireless protocol, for example, Bluetooth®, Wi-Fi®, or another wireless technology. The U-turn signal indicator 630 may include circuitry (not shown) configured to receive the control signals and activate or deactivate the U-turn signal indicator 630 based on the control signals.

The one or more U-turn signal indicators 630 may include, for example, a side marker assembly, for example, as described with respect to FIGS. 1 and 2, a taillight U-turn signal indicator, for example, as described with respect to FIG. 3, a headlight assembly U-turn signal indicator, for example, as described with respect to FIG. 4, or any U-turn signal indicator combination thereof. In some implementations, power for the U-turn indicators may be provided by connections to the vehicle electrical system. In some implementations, a U-turn signal indicator may include a power source, for example, a battery, to provide power to the U-turn signal indicator when the U-turn signal indicator is not connected to the vehicle electrical system.

In some implementations, the U-turn indicator system 600 may be integrated into the vehicle electrical system and control system as part of an original equipment system provided by a vehicle manufacturer. In such embodiments, activation of the U-turn signal indicator may be accomplished with an additional switch incorporated into the vehicle turn signal lever or by an additional turn signal lever position.

In some implementations, the U-turn indicator system 600 may be an aftermarket system installed as a retrofit system. A retrofit system may be provided as a kit that may include one or more U-turn signal indicators, a control module, a control device, or any combination of components described with respect to FIG. 6. In such implementations, activation of the U-turn signal indicator may be accomplished using a control (e.g., a button or switch), for example, as illustrated with respect to FIG. 5. In some implementations, the one or more U-turn signal indicators may be configured in form factors of headlights, taillights, and/or side markers for various makes and models of vehicles to permit interchangeability. In other implementations, the U-turn signal indicators may be installed in addition to the original equipment headlights, taillights, and/or side markers.

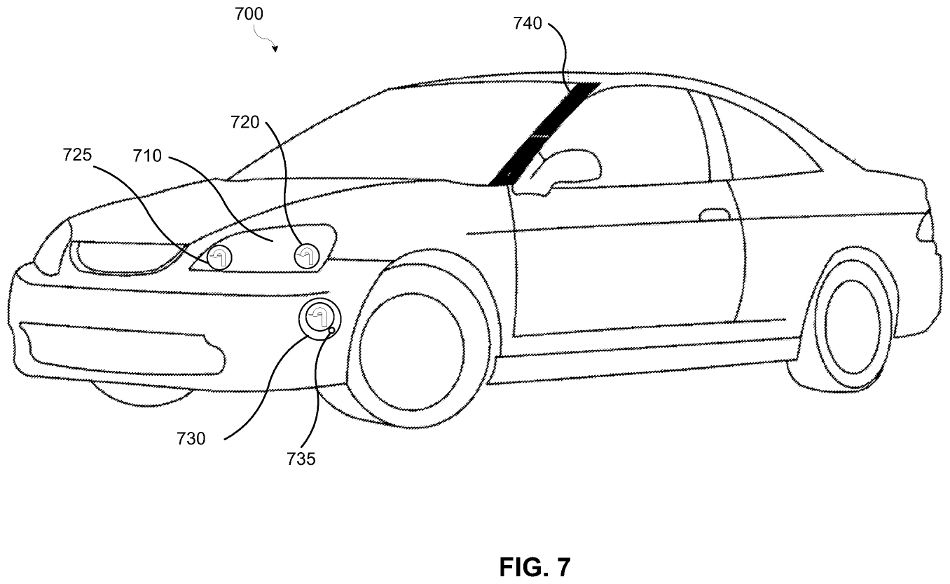

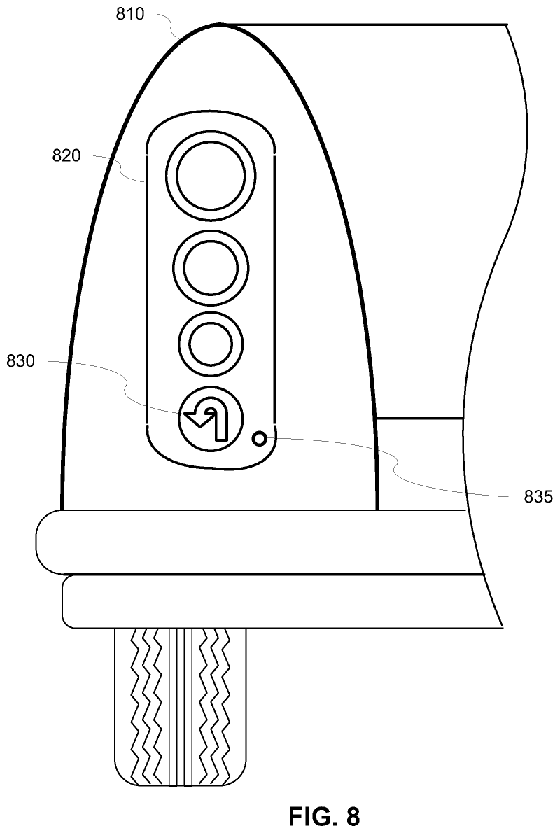

FIG. 7 is a diagram illustrating a headlight and a marker assembly including U-turn indicators disposed in example locations on a vehicle according to some aspects of the present disclosure. As illustrated in FIG. 7, a headlight assembly 710 may include a U-turn signal indicator 720. In some implementations the U-turn signal indicator 720 may be disposed on a lens of the headlight assembly 710 where the lens wraps around from a front portion to a side portion of the vehicle 700. In some implementations, the U-turn signal indicator 720 may be located on a housing of the headlight assembly 710 at a side portion consistent with a direction in which the vehicle may attempt a U-turn. Alternatively or additionally, a U-turn signal indicator 725 may be disposed on a lens of the headlight assembly 710 in a location making it visible to oncoming traffic.

In some implementations, a U-turn signal indicator 730, for example, the U-turn signal indicator/side marker assembly described with respect to FIG. 1 or 2, may be disposed on a front portion of a vehicle body, for example, a fender or a wraparound bumper, a side view mirror, etc., on a side of the vehicle consistent with a direction in which the vehicle may attempt a U-turn. A camera or other proximity sensor 735 may be disposed on the U-turn signal indicator 730 to detect pedestrians or other obstacles that may be located in a driver blind spot caused, for example, by the “A” pillar 740 of the vehicle 700.

FIG. 8 is a diagram illustrating a taillight including a U-turn signal indicator disposed in an example location on a vehicle according to some aspects of the present disclosure. Referring to FIG. 8, a taillight assembly 820, for example, is the taillight assembly as described with respect to FIG. 3, including a U-turn signal indicator 830 and a camera 835, may be located at a rear portion of a vehicle 810 where the taillight assembly 820 is visible to other vehicles approaching the vehicle 810 from the rear. In some implementations, the taillight assembly 820 may not include the camera 835.

The configuration disclosed above as well as other variations of the disclosed configurations may be used, and many variations, modifications, and alternatives may be recognized without departing from the scope of the present disclosure.

The examples and embodiments described herein are for illustrative purposes only. Various modifications or changes in light thereof will be apparent to persons skilled in the art. These are to be included within the spirit and purview of this application, and the scope of the appended claims, which follow.

What is claimed is:

1. A U-turn signal indicator system for a vehicle, the U-turn signal indicator system comprising:
an indicator assembly, including:
a first portion having a first color; and
a second portion configured to form a symbol for a U-turn, the second portion having a second color that contrasts with the first color;
a light emitting element configured to illuminate the first portion and the second portion; and
a control device configured to activate the light emitting element.

2. The U-turn signal indicator system of claim 1, further comprising:
a camera configured to capture an image of an area adjacent to the vehicle in a direction of the U-turn,
wherein the camera is configured to be activated by the control device together with the light emitting element.

3. The U-turn signal indicator system of claim 2, wherein the camera is configured to transmit the image to a video monitor disposed at an interior of the vehicle.

4. The U-turn signal indicator system of claim 1, further comprising:
a proximity sensor configured to sense an object in proximity to the vehicle in a direction of the U-turn and cause an audible alarm to an interior of the vehicle,
wherein the proximity sensor is configured to be activated by the control device together with the light emitting element.

5. The U-turn signal indicator system of claim 4, wherein the proximity sensor is a radar sensor.

6. The U-turn signal indicator system of claim 1, further comprising:
an audible alarm device configured to emit a warning sound external to the vehicle,
wherein the audible alarm device is configured to be activated by the control device together with the light emitting element.

7. The U-turn signal indicator system of claim 1, wherein the control device is configured to activate the light emitting element to cause the first portion of the indicator assembly to illuminate steadily; and
cause the second portion of the indicator assembly configured to form the symbol for the U-turn to flash at a predetermined rate.

8. The U-turn signal indicator system of claim 1, wherein the control device is configured to activate the light emitting element to cause the first portion of the indicator assembly to flash at a predetermined rate; and
cause the second portion of the indicator assembly configured to form the symbol for the U-turn to illuminate steadily.

9. The U-turn signal indicator system of claim 1, wherein the indicator assembly comprises a side marker assembly.

10. The U-turn signal indicator system of claim 9, wherein the side marker assembly comprises:
a camera configured to capture an image of an area adjacent to the vehicle; and
an audible alarm device configured to emit a warning sound external to the vehicle,
wherein the camera and the audible alarm device are configured to be activated by the control device together with the light emitting element.

11. The U-turn signal indicator system of claim 1, wherein the indicator assembly comprises a taillight assembly.

12. The U-turn signal indicator system of claim 11, wherein the taillight assembly comprises:
a camera configured to be activated by the control device together with the light emitting element and to capture an image of an area adjacent to the vehicle.

13. The U-turn signal indicator system of claim 1, wherein the indicator assembly comprises a headlight assembly.

14. A taillight assembly for a vehicle, the taillight assembly comprising:
a U-turn signal indicator including:
a first portion configured to be illuminated in a first color; and
a second portion configured to form a symbol for a U-turn, the second portion configured to be illuminated in a second color that contrasts with the first color.

15. The taillight assembly of claim 14,
wherein the first portion of the U-turn signal indicator is configured to illuminate steadily; and
the second portion of the U-turn signal indicator is configured to flash at a predetermined rate.

16. The taillight assembly of claim 14,
wherein the first portion of the U-turn signal indicator is configured to flash at a predetermined rate; and
the second portion of the U-turn signal indicator is configured to illuminate steadily.

17. The taillight assembly of claim 14, further comprising:
a camera configured to be activated together with the U-turn signal indicator to capture an image of an area adjacent to the vehicle.

18. The taillight assembly of claim 17, wherein the camera is configured to transmit the image to a video monitor disposed at an interior of the vehicle.

19. A headlight assembly for a vehicle, the headlight assembly comprising:
a U-turn signal indicator including:
a first portion configured to be illuminated in a first color; and
a second portion configured to form a symbol for a U-turn, the second portion configured to be illuminated in a second color that contrasts with the first color.

20. The headlight assembly of claim 19, wherein the U-turn signal indicator is disposed on a lens of the headlight assembly at a location visible to oncoming traffic.
